(19) United States
(12) Patent Application Publication
(10) Pub. No.: US 2009/0243264 A1
(43) Pub. Date: Oct. 1, 2009

(54) Cover for an airbag and method for the production thereof

(76) Inventor: Nicole Kaulbersch, Leinfelden (DE)

Correspondence Address: KRIEGSMAN & KRIEGSMAN, 30 TURNPIKE ROAD, SUITE 9, SOUTHBOROUGH, MA, 01772, US

(21) Appl. No.: 11/918,966

(22) PCT Filed: Jan. 30, 2006
(86) PCT No.: PCT/EP2006/000782

§ 371 Date: May 15, 2009

(30) Foreign Application Priority Data
Apr. 20, 2005 (EP) 05008603.2

(51) Int. Cl. B60R 21/215; B23P 13/00

(52) U.S. Cl. 280/728.3; 29/557

(57) ABSTRACT

The invention relates to a cover for covering an airbag in the interior of a motor vehicle, said cover consisting of a material comprising interspaced perforations which fully penetrate the material in the region of the edge of the airbag flap, said perforations having an essentially linear form and a maximum length of 0.8 mm. The invention also relates to a method for producing a cover for covering an airbag in the interior of a motor vehicle.

The present invention relates to a cover for covering an airbag and to a method for the production thereof.

Nowadays, airbags are integrated in motor vehicles at various locations, for example in steering wheels, dashboards, doors, seats, roof linings, etc. For reliable functioning of the airbag, all of the layers of the plastic support have to have one or more material weakenings, that are referred to as predetermined breaking points, which define the firing channel of the airbag.

In the sphere of airbag coverings, it is customary—especially when the material is leather—to provide the covering of the airbag in the region of the airbag flap with an “airbag documentation seam” such that said covering can open without obstruction during an impact and the airbag can be deployed.

However, for visual reasons and/or because of the design, motor vehicle manufactures increasingly require the front passenger airbag, for example, which is integrated in the dashboard, to be designed invisibly on the side facing the occupant. For this purpose, the dashboard with the airbag flap integrated therein is provided with a cover without an airbag documentation seam. However, said cover likewise has to have a material weakening in the region of the edge of the airbag flap such that reliable opening of the airbag flap and deployment of the airbag in the event of an impact continue to be ensured.

In addition, the opening of the cover along the material weakenings has to take place within a predetermined time window. Also, an uncontrolled flight of particles due to cover fragments flying around has to be avoided in every case.

Airbag covers of this type are known from different materials, for example from plastic sheets, cloth materials, textiles, slush, imitation leather or from leather. In the case of superior vehicle fittings, the covers are ever more frequently produced from leather. Leather does not have any homogeneous material properties and, in its natural, three-dimensional fiber structure, possesses extremely high strength, which necessitates a particularly pronounced material weakening for leather in order to permit unobstructed deployment of the airbag.

These functional requirements while at the same time observing the design specification of “invisibility” constitute a great technical challenge which, especially in the case of leather as the material, can be classified as being technically very demanding.

In order to achieve effective tearing open or having an attractive visual design, DE 101 26 911 A1 has proposed providing the inside of the covering with multiple cutting lines by means of which a reliable and defined formation of a tear along the predetermined breaking line without an uncontrolled flight of particles can be achieved even at low temperatures. In order to obtain an attractive surface, the incisions should always have a cutting depth located throughout below the wall thickness of the decorative skin, and therefore the residual wall thickness of the material is maintained.

However, weakenings of the cover material by scoring have the disadvantage that, in the case of a deep incision, the notch gapes and therefore the notch also becomes visible on the visible side of the cover over the course of time due to the temperature changes to which the cover and the motor vehicle are subjected. Smaller cutting depths have a negative effect on the tearing-open behavior.

EP 1 213 193 A1 proposes perforating the airbag covering in the region of the edge of the airbag compartment lid and subsequently smoothing it out again with a suitable filler in order to cover the openings on the visible side. Although the effect which can be achieved by this is that the perforations can no longer be seen by the vehicle occupants, this method is costly, since, after the insertion of the perforations, the leather has to be brought back again to the leather supplier.

In order to provide airbag covers which are invisible to the vehicle occupants with a controlled tearing-open behavior, DE 100 55 546 A1 proposes producing weakening structures running along a predetermined breaking line, the weakening structures being recesses produced on the inside of the material by means of a punching tool. The desired tearing-open behavior is to be achieved by a suitable selection of the sequence and depth of the recesses, with the outside of the covering that faces in the direction of the vehicle interior being undamaged, wherein, again in this method, a residual wall thickness of the material is maintained.

Even if, with this cover, the desired tearing-open behavior is achieved and the outwardly pointing surface of the covering remains intact in the form of a “residual wall” such that no undesirable, outwardly visible cuts are visible, even these coverings do not satisfy the required invisibility, since, again, the cuts gape under the effect of temperature and therefore become visible on the visible side of the cover.

Specially in the case of the natural material leather, the required invisibility by means of the described methodology cannot be ensured even under room temperature, since the leather fibers are greatly crushed and compressed over the course of the punching process. This “leather-unfriendly” material treatment causes the leather to have visible flashing regions on the visible side.

DE 196 36 428 A1 teaches forming the weakening line for the predetermined breaking point as a perforation line (blind holes) which penetrates the airbag casing approximately as far as the surface visible to the vehicle occupant. The “perforation lines” known from this application are not continuous perforations but rather blind holes and thus again material weakenings using the residual wall thickness.

In order to make it difficult to visually perceive, on the visible side, depressions which may form in the remaining residual wall in the bottom of the perforation hole, this document teaches arranging the blind holes such that they deviate from the weakening line, for example in a stochastic linear route or else in a defined linear profile, such as, for example, sinusoidally or in serrated form.

Weakenings by means of an existing residual wall in the rear side of the cover material always lead, as mentioned, to failure of the predetermined breaking points during climate change tests.

Furthermore, it is known to weaken the cover by means of laser methods. However, difficulties occur in the laser-based methods, since the desired invisibility of the weakening cannot be ensured, in particular in the case of light leather colors. Also, such laser-weakened materials have led during firing tests to excessive opening times—primarily because of the hardening due to energy-rich radiation in the edge regions of the weakenings produced.

In order to solve the problem of invisibility of the predetermined breaking line in the covering even under the effect of temperature and moisture and material aging, DE 102 31 131 A1 has proposed leaving the outer airbag covering intact and simply providing a second layer which is to predetermine the profile of the tearing seam. The covering and the second layer are interconnected, and therefore, as a result of the restricted expandability of the two interconnected layers, the airbag covering is to tear open in the region in which there is a weakening region only in the second layer. However, such a covering does not exhibit the desired, defined tearing-open behavior, and, in addition, an undesirable flight of particles sometimes occurs.

The present invention is based on the object of proposing a cover in the form of a covering of an airbag and a method for the production thereof, the weakening of which cover ensures a reliable tearing behavior which exists even under climate effects, wherein the weakening cannot be seen at any time from the visible side and therefore in the vehicle interior and, in addition, the weakening can be inserted into the cover in a simple manner.

The object is achieved by a cover for covering an airbag in the interior of a vehicle, which cover has interspaced perforations which penetrate the material in the region of the edge of an airbag flap, the perforations having an essentially linear form, and the length of a perforation not being more than 0.8 mm. It has surprisingly been established that, by means of such perforations which fully penetrate the material and have lengths in the micrometer range, covers with the desired tearing-open behavior can be produced and, despite the perforations passing through the leather, said perforations are not visible from the side facing the occupant.

The perforations are preferably arranged one behind another. However, the perforations can also be arranged statistically or chaotically over a certain region.

Furthermore, by means of these perforations in the micrometer range, it is entirely or at least virtually entirely ruled out that the weakening structures will become visible under climate effects.

The retrospective closing of the perforation to make it invisible, which is known from the prior art, is therefore not required, and therefore the cover material, such as, for example, leather, can be completely finished before the perforations are inserted.

In addition, the elongate (linear) extension of the perforations facilitates the tearing-open of the cover. In contrast to notches being cut in, the elongate perforations do not gape even under climate effects, and therefore, despite being highly effective, they are not visually obtrusive.

In particular in the case of leather as the material, the elongate extensions of the perforations are invisible from the visible side, since the finish of the material automatically closes itself again after the microperforations have been inserted.

For this purpose, the perforations are arranged one behind another and are interspaced. The length of a perforation is preferably not more than 0.6 mm, with the preferred range being between 0.2 and 0.4 mm, and therefore being in a range which approximately corresponds to the average size of a pore in the leather. A range of between 0.25 and 0.35 mm is particularly preferred.

In addition, the full penetration of the cover material by means of the perforations surprisingly achieves a significant improvement in the percental weakening of the leather in comparison to the residual wall weakening methods. This is to be attributed to the fact that the visible side of the leather, which has the greatest tensile strength, is only compressed during the residual wall weakening and therefore the fibers are not severed, with the compression of the residual wall remaining during the residual wall weakening operation additionally also stabilizing said residual wall and therefore tearing is made more difficult.

However, it is precisely this outer layer of the leather with the greatest tensile strength which is severed in the case of the cover according to the invention with the continuous perforations, and this leads, overall, to better tearing-open properties of the cover according to the invention.

Such a perforation according to the invention is understood as being any incision, any hole, any opening, any cutting channel and any piercing in the cover material that fully penetrates the cover material. The perforations are preferably cutting or punching channels which have a rather elongate appearance because of the shape of the tool. The shape of a perforation is preferably elongate and, in particular, essentially rectangular, in particular in the form of a short straight line.

In order to insert such a perforation, the tool used for this purpose is preferably a perforation blade or perforation cutting edge with a blade or cutting edge length lk of at maximum 0.8 mm, preferably with a blade or cutting edge length lk of at maximum 0.6 mm and, in the range which is particularly preferred, with a blade or cutting edge length lk of between 0.2 and 0.4 mm, preferably between 0.25 and 0.35 mm, in particular approximately 0.3 mm and preferably ground on both sides thus producing a rectilinear, blade-shaped and very sharp cutting surface S.

After the perforation is carried out with a sharp blade or cutting edge, all of the leather fibers extending over the material depth are severed to the length of the perforation. The width of the perforation is also extremely small and is generally not more than 0.2 mm and preferably at maximum 0.1 mm, with the width of a perforation particularly preferably being essentially constant over the entire length.

The perforations are preferably essentially regularly interspaced, since good tearing-open behavior along the entire airbag flap can thereby be obtained. A partial consolidation of the perforations to certain locations or in certain regions can likewise have a positive effect on the tearing-open behavior in this region.

The distance a between the center point of a perforation and the adjacent center point of the next perforation depends on the length of the perforation 1 and on the material properties and on whether the perforations are arranged along one line or along a plurality of lines or in some other way. In order to permit tearing open at all, the center points of two perforations should not be further away from each other than three times the perforation length l, and, in particular, should be between 1.1 to 1.5 times the length l of a perforation, in particular if the perforations are arranged along a common line. In principle, even a distance a=l is possible, since, owing to the material properties of the leather, minimal material webs still always remain.

If the perforations are arranged on two lines running essentially parallel to each other (weakening geometries), then the distance a between the center points of two adjacent perforations from each other on a line is at maximum three times, in particular approximately 1.3 to 1.7 times, the length l of a perforation. It is particularly advantageous if the perforations arranged on the other line are then interspaced at the same distance a, with a perforation on the first line being arranged approximately between two perforations on the second line. The distance b of the two lines from each other should be at maximum 1.5 times the perforation length l and, particularly preferably, 0.3 to 0.7 times the perforation length l. Of course, it is likewise possible to provide more than two lines, in particular running essentially parallel to one another.

Since the perforations are to be located above the edge of the airbag flap and deviations in the seat of the weakening structure may occur due to production and materials, a further preferred embodiment makes provision to design the weakening structure not as a straight line but rather as a line weakening a region of a certain width, for example by means of a zigzag-shaped, sinusoidal or a wave-shaped profile or a different, repetitive, uniform geometry. The effect achieved by this is that even a weakening because of the expansion of leather or a weakening which in some regions is slightly offset with respect to the position of the airbag still comes to lie above the opening line of the airbag flap.

A further substantial advantage of this nonlinear weakening profile is that the eye no longer perceives such a nonlinear line or a line which is straight only over a short section as a line, that is to say the visual perceptibility of the perforations is also reduced by the nonrectilinear routing. In addition, the orientation of the weakening structure in a zigzag, sinusoidal or wave shape produces a tearing-open behavior which ensures in the long term a reliable response behavior under a desired loading.

The reliability of the tearing open of the cover can be further increased by the provision of a plurality of weakening lines and the offset arrangement of the perforations on two adjacent lines and the orientation of the perforation blade or perforation cutting edge for the desired linear representation of a weakening structure (rotation of the perforation blade/alignment of the perforations with the weakening structure).

If the profile of the weakening structures is wave-shaped or sinusoidal, then the maximum value of the elongation of the weakening structure (amplitude) is generally between 0.75 mm and 3.5 mm, and, in particular, is approximately 1.25 mm. The wave-shaped profile of the line also imitates the natural surface composition of the leather, which also contributes to the cuts being invisible to the human eye.

A zigzag-shaped profile of the line is also possible, but two maxima of the zigzag lines should not be too closely adjacent so as to avoid a flight of particles. In general, the distance between two peaks should not be less than 2 mm and, in particular, should be between 2.5 mm and 10 mm.

The thickness of the cover material itself can be from, for example, 0.4 mm to 1.6 mm, in particular if it is composed only of one material layer. The cover material is preferably made from leather or comprises leather, leather with a coating or leather in the material composite or imitation leather or slush as the cover material.

According to the described method, the weakening of a composite made of two fixedly interconnected material layers, with the one material layer consisting of an automobile decorative material (leather, imitation leather or the like), and the second material consisting of a foam, spacer knit, nonwoven, textile or the like, is likewise possible.

The invention also relates to a method for the production of a cover for covering an airbag in the interior of a motor vehicle, in which perforations which are arranged one behind another, are interspaced, fully penetrate the cover material and have a maximum length of 0.8 mm are inserted—preferably from the inside of the cover material (flesh side of the leather)—in the unlaminated state thereof, in the region which essentially covers the edge of the airbag flap after the cover material is laminated onto the covering of the airbag.

The production of the perforations preferably takes place without heat being produced, since, as a result, unlike, for example, in the case of the use of lasers, the individual fibers of the leather are not acted upon thermally and consequently harden.

For the production of the perforations, use can be made of a tool with an elongated, knife-edge-like perforation blade. In the case of perforations which can constitute any desired pattern in linear form, the tool is always rotated, as the perforations continue, in such a manner that the longitudinal direction of the blade is oriented to the linear form to be obtained, that is to say, reproduces the desired linear form as exactly as possible or is oriented parallel to or very substantially congruently to the desired linear form.

Further alternatives of the present invention make provision to prelaminate the cover material with a second material layer and only then to weaken it. The cover material can also not be weakened from the suede side/rear side, but rather from the visible side. A further refinement makes provision to use a punch-like tool with a multiplicity of individual blades to provide simultaneous perforation in order to weaken the cover material.

Furthermore, invisible weakenings in the airbag cover have the advantage that, as a consequence of their invisibility, they are not subject to any design requirements and can therefore be placed in a defined manner over the weakened region of the support material. Any desired radius can be realized, since the design does not have to be taken into consideration and the technical configuration of the invisible airbag can be focused merely on its functionality. For example, it is no longer required to place the predetermined breaking point of the airbag (the airbag seem according to the prior art) parallel to the decorative seams.

The invention is described in more detail below with reference to figures, exemplary embodiments and comparison tests. In the drawings:

FIG. 1 shows a cross section through a cover according to the invention with a perforation,

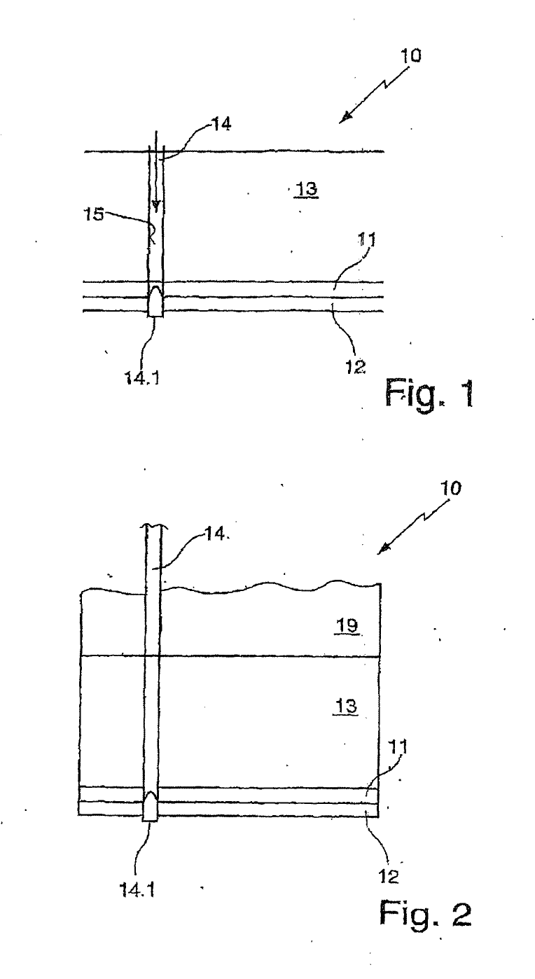

FIG. 2 shows a cross section through a cover according to the invention in a material composite with a perforation,

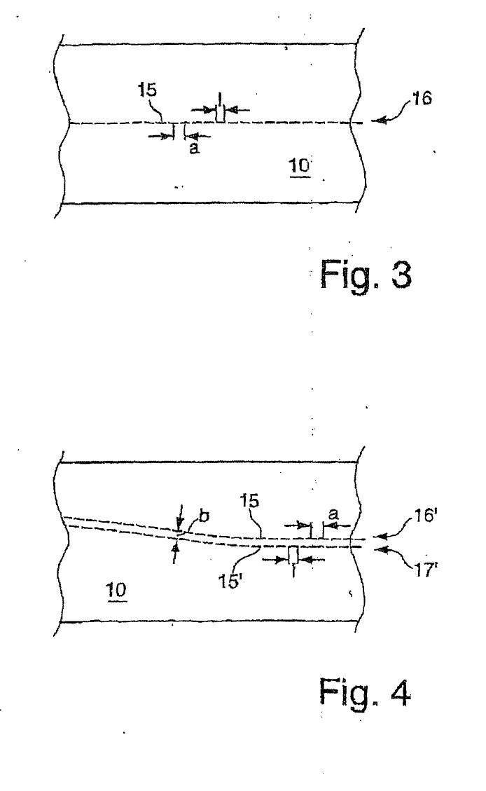

FIG. 3 shows a plan view of the inside of partial sections of the cover in FIG. 1 or 2 with perforations which form a weakening structure following a straight line,

FIG. 4 shows a plan view of the insides of the partial sections of the cover in FIG. 1 or 2 with perforations which form a weakening structure deviating from a straight line,

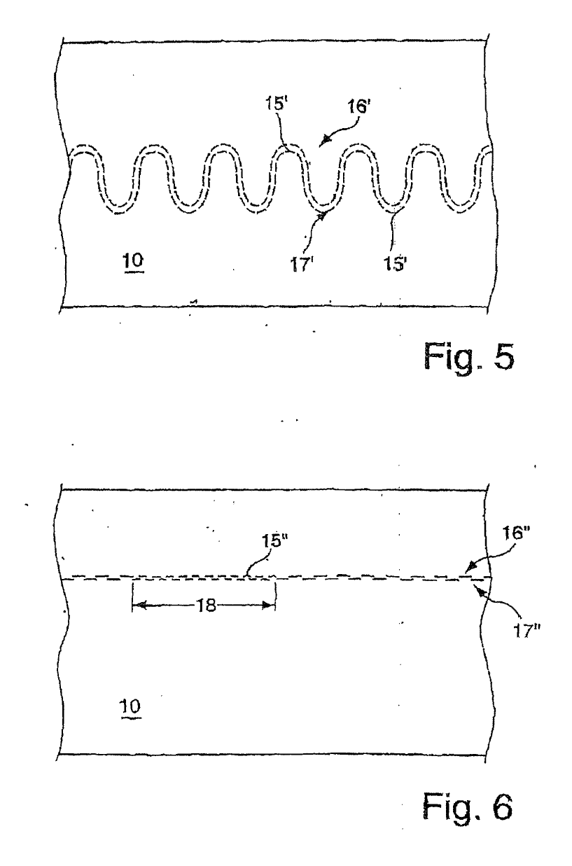

FIG. 5 shows a plan view of the inside of a partial section of a cover with wave-shaped weakening structures,

FIG. 6 shows a plan view of the inside of a partial section of a cover with partial consolidation of the perforations to a particularly preferred location,

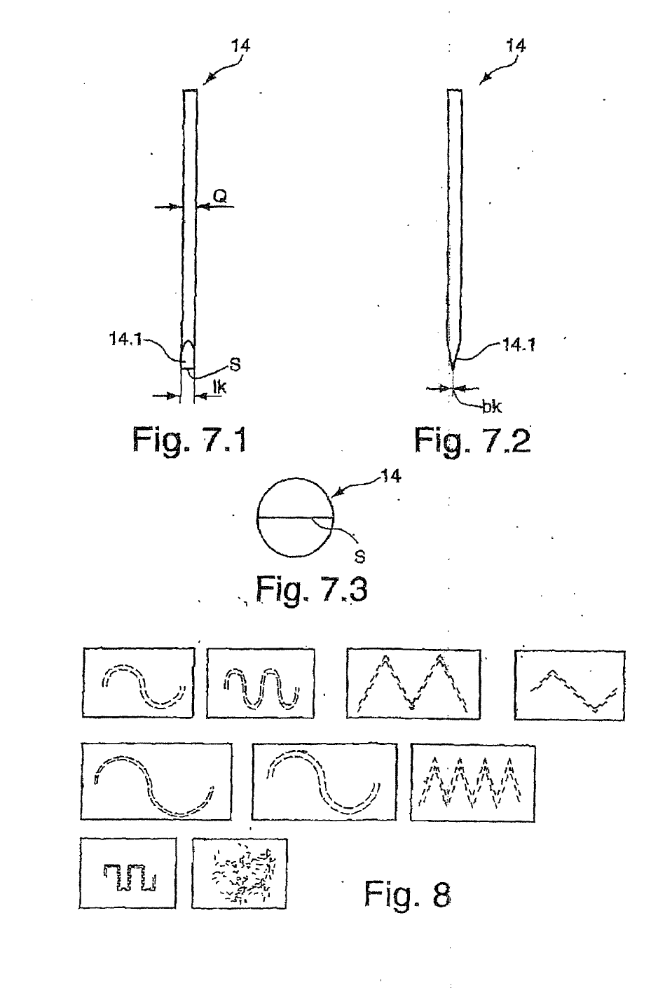

FIG. 7.1 shows a front view of a tool for inserting perforations into the cover,

FIG. 7.2 shows a side view of a tool for inserting perforations into the cover,

FIG. 7.3 shows a plan view of a tool for inserting perforations into the cover,

FIG. 8 shows an enlarged illustration of various further weakening profiles and the position and spacings of the perforations with respect to one another, and

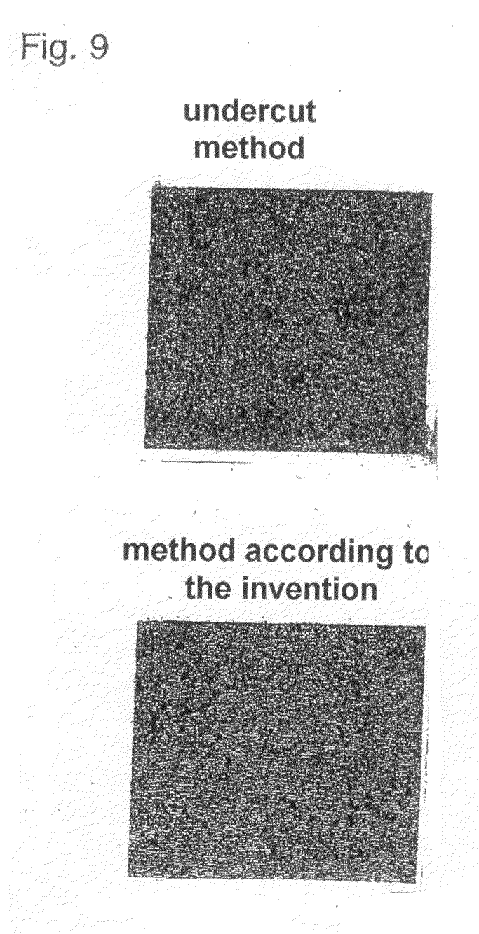

FIG. 9 shows a comparison test involving a climate change test.

FIG. 1 shows, in cross section, a cover material 10 made of leather, the outer layer/skin layer 11 of which is already finished and is provided with a colored layer, the “finish” 12. The outermost region of the outer layer 11, which region is directly adjacent to the finish, has the greatest tensile strength. Perforations 15 are inserted from the inside 13 (flesh side of the leather), which is also referred to as the suede side, with the aid of a tool 14 with perforation blades 14.1, said perforations being produced by vertical introduction of the tool 14 including the blade 14.1 into the inside 13, with the perforations 15 fully penetrating the skin layer 11 and the colored layer 12. FIG. 2 shows, in cross section, a cover material 10 which is made of leather and is perforated in a composite with another automobile decorative material 19.

As FIGS. 3 and 4 explain, the perforations 15, 15′ which are inserted with the aid of the tool 14 can lie on a line 16 or a plurality of parallel lines 16′, 17′ which follow a straight line or form weakening structures deviating from a straight line, with it being possible for the length l of the perforations 15 to approximately correspond to the distance a between two perforations 15. In the example illustrated, the distance b of the two lines 16 and 17 from each other is approximately 0.5 times the length l of the perforations 15. However, any desired variations are possible here. In the example illustrated, the perforations 15 of lines 16 and 17 are also offset with respect to each other. This arrangement is favorable in order to have a positive effect on the tearing-open behavior.

Like FIGS. 3 and 4, FIG. 5 shows a plan view of a partial section of a cover material 10, in particular an automobile decorative material, such as leather, imitation leather, fabric or the like. Weakening structures 16′ and 17′ are of wave-shaped design, and the perforations 15′ are placed in such a manner that, as the perforations 15′ continue, the tool 14 is always rotated to an extent such that a desired wave shape or any other desired shape of one or more weakening structures 16′ and 17′ can be produced. Desired perforating/weakening structures which exhibit a uniform tearing-open behavior under load can be produced by the perforations 15′. The perforating/weakening structures are selected in such a manner that they are not visible even if they fully penetrate the cover material 10 or the material composite 10 and 19.

The perforation operations according to the invention into the cover material 10 or into the material composite 10 and 19 always take place from the inside 13, 13′ (flesh side) in the unlaminated state of the cover material 10 or the material composite 10 and 19.

Like FIGS. 3, 4 and 5, FIG. 6 shows a plan view of a partial section of a cover material 10, in particular an automobile decorative material, such as leather, imitation leather, fabric or the like. The weakening structures 16″ and 17″ are designed rectilinearly, and the perforations 15″ are placed in such a manner that they have a partial consolidation of the perforations in the region 18.

FIGS. 7.1, 7.2 and 7.3 show the tool 14 for producing the perforations 15 in side view 7.1, in front view 7.2 and in plan view 7.3. At its tip, the tool 14 has a tapering in the form of a perforation blade or perforation cutting edge 14.1 which produces the perforations 15, 15′, 15″ in the cover material 10 or in the material composite 10 and 19. In the form illustrated, the tool 14 has a circular cross section Q. However, it may also be advantageous if the tool has a square or rectangular cross section since, in such cases, the tool can always be fixed in an aligned manner in the tool holder. The tool used according to the invention has a sharp, preferably ground cutting surface or blade surface S.

The cutting edge or blade of the tool should preferably be formed in such a manner that the leather fibers are not pushed away laterally during vertical lowering of the cutting edge but rather the fibers are subjected to a force which acts vertically from above and which then leads, during further lowering of the cutting needle, to cutting of the fibers.

It is advantageous to insert the tool at a very high acceleration or speed into the material such that the leather fibers cannot yield laterally because of their inertia.

A round blade with a conical tip would be less suitable, since most of the fibers would not be cut with such a geometry but rather would merely be displaced laterally along the conical needle tip such that the fiber structure bringing about the strength is not completely severed, as is the case, for example, with commercially available sewing needles.

In order to achieve effective severing of the required number of fibers over a certain length, the tool tip is formed in a manner similar to the tip of a screwdriver, and the cutting edge S itself is line-shaped or rectangular with two very long and two very short edges.

In principle, the cutting edge of the tool may also be formed differently, for example with a rather more triangular or rather more square basic area or else half-moon-shaped, as long as a maximum length of the cut of less than 0.8 mm is ensured and the cut is not of such a width that the cut gapes when the leather is pulled apart and is therefore readily visible.

Furthermore, the blade which is flat and runs horizontally has the advantage that the cutting surface is subject to less wear. In the case of the covers according to the invention, as a result of the material being completely pierced, webs remain between two adjacent recesses and are supplemented to form a perforation line running along the weakening structure.

Furthermore, it may be advantageous to fixedly fit two structurally identical perforation tools at a defined distance from each other and thus to weaken the cover material simultaneously on parallel weakening structures, as a result of which the required manufacturing times can be reduced. In this case, the tools can be interconnected in a defined manner preferably at a distance of not less than 0.1 mm.

In order to produce weakening structures in a cover material for covering an airbag flap, perforations 15, 15′, 15″ are produced on the inside 13 of the cover material 10 by a tool 14 with a perforation blade 14.1, the perforations 15, 15′, 15″ being inserted into the cover material 10 from the inside 13 via intermittent cuts or punchings. The weakening structure produced via the perforations 15, 15′, 15″ is selected such that i, deviates from a straight line, and therefore a constant, reliable, defined tearing-open behavior of the cover material 10 under load is ensured. In the case of any desired linear representations of weakening structures which are produced by the perforations, the blade or cutting edge of the tool can be aligned, in a preferred embodiment, with the desired linear representation, that is to say, the blade or cutting edge of the tool is aligned with the weakening structure to be produced. Aligned in this connection means that the cutting edge or blade of the tool is oriented along a desired linear route or parallel thereto.

FIG. 8 illustrates schematically further possible profiles of weakening structures, profiles of the weakening structures with respect to one another and arrangements of the perforations and the length thereof. The last figure shows that even the statistical distribution of the perforations over a certain region is possible in principle.

### Comparison Tests

Leather sections were tested, in which
a) the weakening was inserted by means of laser “laser method”,
b) leather sections in which the weakening was inserted by means of an undercut and was machined to the residual wall thickness (“undercut”)
   a) leather sections, with the perforations which, according to the invention, pass fully through the leather and are arranged in each case two rows running parallel to each other, with the perforations in one row being staggered with respect to the perforations of the other row.

The results of the individual comparison tests are summarized in the table below and are described subsequently:

| | | | c) Method |
|---|---|---|---|
| | | | according to |
| | a) Laser | | the |
| | method | b) Undercut | invention |
| 1. Visibility | Clearly | Slightly | Invisible |
| of the | visible | visible | |
| weakening | | | |
| before the | | | |
| beginning of | | | |
| the test | | | |
| 2. Impression | | No change | No change |
| test | | visible up | visible up |
| | | to 320 N | to 323.56 N |
| 3. Rubbing | | No changes | No changes |
| fastness | | visible; | visible; |
| test, dry | | gray scale 5 | gray scale 5 |
| 4. Rubbing | | No changes | No changes |
| fastness | | visible; | visible; |
| test, wet | | gray scale 5 | gray scale 5 |
| 5. Media | | No changes | No changes |
| resistance | | visible | visible |
| (drip test) | | | |
| 6. Sun | | Weakening | Weakening |
| simulation | | visible | not visible |
| 7. Climate | | Weakening | Weakening |
| change test | | clearly | not visible |
| | | visible | |
| 8. Tensile | 65. 25% of | 82. 65% of | 50. 60% of |
| test | the tensile | the tensile | the tensile |
| | force still | force still | force still |
| | required | required | required |

The results of the test series carried out—impression test, rubbing fastness test, dry and wet, and the drip test are not specified in more detail because of their parallel results.

The test results of the climate change test carried out and of the sun simulation and tensile tests will be explained in more detail below:

### 6. Sun Simulation

The test is based on DIN 75220

### Parameters:

indoor conditions; stress zone 1
15 cycles of dry climate: 80+/−3° C.; <30% r.h. 830+/−80 W/m²
10 cycles of moist climate: 80+/−3° C.; >40% r.h. 830+/−80 W/m²

### Objective:

No changes in the color shade or in the structure of the surface
No opening or appearance of the weakening structure

### 7. Climate Change Test

### Parameters:

30 cycles
4 hours/10° C./92% rh+2 hours/120° C./max. 20% rh

### Objective:

no changes in the color shade or in the structure of the surface
No opening or appearance of the weakening line

The view of the weakening structure from the undercut method and the method according to the invention is illustrated in attached FIG. 9.

### 8. Tensile Test

### Parameters:

weakened and 10 unweakened samples in each case
samples have to lie in the same direction of tension
taking of samples takes place closely together

### Objective:

Defined tearing of the weakening structure; great differences of unweakened over weakened leather (great weakening success). This corresponds to a small percental value of the tensile force which is still required (after weakening).

1. A cover for covering an airbag in the interior of a motor vehicle, which cover is made from a cover material which has interspaced perforations which fully penetrate the material in the region of the edge of the airbag flap and have an essentially linear form, characterized in that the length of said perforations is not more than 0.8 mm.

2. The cover as claimed in claim 1, characterized in that the perforations are arranged one behind another.

3. The cover as claimed in claim 1, characterized in that the length of a perforation is not more than 0.6 mm and in particular is between 0.2 and 0.4 mm.

4. The cover as claimed in claim 1, characterized in that the width of the perforation is not more than 0.2 mm and preferably is not more than 0.1 mm.

5. The cover as claimed in claim 1, characterized in that the perforations are essentially regularly interspaced.

6. The cover as claimed in claim 1, characterized in that the number of perforations is partially consolidated/increased or reduced in some regions.

7. The cover as claimed in claim 1, characterized in that the distance a between the center points of two adjacent perforations is at maximum 3 times and, in particular, 1 to 1.5 times the length l of the perforation, in particular if the perforations are arranged along a common line.

8. The cover as claimed in claim 1, characterized in that the distance a between the center points of two adjacent perforations is at maximum 3 times and, in particular, 1.3 to 1.7 times the length l of the perforation, in particular if the perforations are arranged along a plurality of lines arranged essentially parallel to one another.

9. The cover as claimed in claim 1, characterized in that the perforations lie essentially on one or more straight or curved lines, in which case, if the perforations lie on the plurality of lines, they run essentially parallel to one another and their distance b from one another is at maximum 1.5 times the perforation length l and, particularly preferably, between 0.3 and 0.7 times the perforation length.

10. The cover as claimed in claim 1, characterized in that the perforations are arranged on at least two mutually parallel lines, and the perforations on the first line are essentially staggered with respect to the perforations of the second line.

11. The cover as claimed in claim 1, characterized in that the lines are straight and/or curved (alternating) lines and/or are zigzag-shaped, wave-shaped or sinusoidal or run in a repetitive, uniform geometry in the region of the weakening line.

12. The cover as claimed in claim 1, characterized in that the amplitude of a weakening structure is between 0.75 and 3.5 mm and, in particular, is approximately 1.25 mm.

13. The cover as claimed in claim 1, characterized in that the cover material is made from leather or comprises leather, in particular leather with a coating or leather in the material composite or imitation leather or slush.

14. The cover as claimed in claim 1, characterized in that a composite made of two fixedly interconnected material layers is provided as the cover material, with the one material layer consisting of an automobile decorative material, such as leather or imitation leather, and the second material layer consisting of a foam, spacer knit, nonwoven or textile.

15. The cover as claimed in claim 1, characterized in that the thickness of the cover material with just one material layer is 0.4 mm to 1.6 mm.

16. The cover as claimed in claim 1, characterized in that the thickness of the cover material which has at least two interconnected material layers is more than 0.5 mm and, in particular, between 1 and 20 mm.

17. A method for the production of a cover for covering an airbag in the interior of a motor vehicle, in particular as claimed in claim 1, characterized in that perforations which are arranged one behind another, are interspaced, fully penetrate the cover material and have a maximum length of 0.8 mm are inserted into the cover material from the inside of the cover material in the unlaminated state thereof, in the region which covers the edge of the airbag flap after the cover material is laminated onto the covering of the airbag.

18. The method as claimed in claim 17, characterized in that the perforations are inserted with the aid of a tool which has an elongated, knife-edge-like blade or cutting edge with a very sharp cutting surface.

19. The method as claimed in claim 17, characterized in that the cutting and perforating blade of the tool runs parallel to the upper side of the leather during the perforating operation.

20. The method as claimed in claim 17, characterized in that, during the production of any desired weakening geometry, the tool moves forward in a defined up-down movement with intermittent punching.

21. The method as claimed in claim 17, characterized in that the length of the blade is not more than 0.8 mm, in particular is between 0.2 and 0.4 mm and, in particular, is between 0.25 and 0.35 mm.

22. The method as claimed in claim 17, characterized in that the width of the blade at its frontmost cutting surface is not more than 0.2 mm and, in particular, is smaller than 0.1 mm.

23. The method as claimed in claim 17, characterized in that, during the production of a weakening geometry deviating from a straight line, the tool rotates and is aligned with the desired route of the weakening geometry.

24. The method as claimed in claim 17, characterized in that two or more parallel weakening lines are inserted simultaneously into the cover material with the aid of two or more tools arranged at a minimum fixed mutual distance of 0.1 mm.
